(19) United States
(12) Patent Application Publication
(10) Pub. No.: US 2016/0214725 A1
(43) Pub. Date: Jul. 28, 2016

(54) CABIN AIR EXTRACTION SYSTEM, METHOD FOR OPERATING A CABIN AIR EXTRACTION SYSTEM AND AIRCRAFT AIR-CONDITIONING SYSTEM

(71) Applicant: Airbus Operations GmbH, Hamburg (DE)

(72) Inventors: Bernhard Holtrup, Hamburg (DE); Philip Kuhnke, Hamburg (DE)

(21) Appl. No.: 15/006,298

(22) Filed: Jan. 26, 2016

(30) Foreign Application Priority Data
Jan. 27, 2015 (DE) 102015201342.1

(51) Int. Cl. B64D 13/06; B64D 13/08

(52) U.S. Cl. CPC B64D 13/06; B64D 13/08; B64D 2013/0651; B64D 2013/003

(57) ABSTRACT

A cabin air extraction system comprising a cabin waste air line and a conveying apparatus which conveys, through the cabin waste air line, waste air to be discharged from an aircraft cabin. A filtering apparatus filters at least part of the cabin waste air flowing through the cabin waste air line. Finally, the cabin air extraction system comprises a filtered air line which conducts at least part of the air which has been filtered by the filtering apparatus to a consumer device present on board an aircraft equipped with the cabin air extraction system.

### CROSS-REFERENCES TO RELATED APPLICATIONS

This application claims the benefit of the German patent application No. 10 2015 201 342.1 filed on Jan. 27, 2015, the entire disclosures of which are incorporated herein by way of reference.

### BACKGROUND OF THE INVENTION

The invention relates to a cabin air extraction system, a method for operating a cabin air extraction system and also an aircraft air-conditioning system.

Modern commercial aircraft are usually equipped with a cabin air extraction system which serves to conduct waste air and unpleasant odors out of the aircraft cabin and into the environment around the aircraft. The cabin air extraction system comprises a cabin waste air line in which there is arranged a conveying apparatus which is constructed, for example, in the form of a blower. By means of this conveying apparatus, cabin waste air is conveyed out of the cabin through the cabin waste air line and finally discharged to the environment around the aircraft via a waste air valve provided in the area of an outer skin of the aircraft. A cabin air extraction system of this kind is described, for example, in EP 2 799 343 A1 and US 2014/299290 A1.

In a passenger aircraft, moreover, the passenger cabin or partial areas of the latter, the cargo hold or partial areas of the latter, the cockpit and the rest rooms for the crew constitute different air-conditioning zones which are air-conditioned by means of the aircraft's own air-conditioning installation when the aircraft is in operation, both in flight and when it is on the ground. Process air, which is hot and at an elevated pressure and which is taken, either from the aircraft's engine compressors or its auxiliary engine compressors, or is produced by a separate compressor, is fed to the aircraft air-conditioning installation. Within the air-conditioning units, the so-called “air-conditioning packs” of the aircraft air-conditioning installation, the process air is expanded and cooled down to a desired low temperature. Finally, the air which has been processed in the air-conditioning units is fed, in the form of cooled fresh air, into a mixer where it is mixed with recirculation air which has been sucked out of the passenger cabin. The mixed air which is produced in the mixer and comprises cold fresh air made available by the air-conditioning packs and recirculation air sucked out of the aircraft cabin is finally used for air-conditioning the various air-conditioning zones of the aircraft.

### SUMMARY OF THE INVENTION

An underlying object of the invention is to make available a cabin air extraction system and also a method for operating a cabin air extraction system which permit energy-efficient and fuel-saving operation of an aircraft equipped with the cabin air extraction system. The invention is also directed towards an object of indicating an aircraft air-conditioning system which is equipped with a cabin air extraction system of this kind.

A cabin air extraction system comprises a cabin waste air line and a conveying apparatus which is adapted to convey, through the cabin waste air line, waste air which is to be discharged from an aircraft cabin. A first end of the cabin waste air line may be connected, for example, to a passenger cabin or an area of the latter, in particular, a galley area of an aircraft equipped with the cabin air extraction system. The conveying apparatus may be constructed, for example, in the form of a blower. As an alternative to this, however, a venturi nozzle or other conveying apparatus operating on the differential pressure principle may be used for conveying, through the cabin waste air line, the air which is to be discharged from the aircraft cabin.

The cabin air extraction system also comprises a filtering apparatus which is adapted to filter at least part of the cabin waste air flowing through the cabin waste air line. The filtering apparatus may comprise, for example, an activated carbon filter which is suitable for filtering unpleasant odors and other undesired substances out of the cabin waste air. Finally, the cabin air extraction system is equipped with a filtered air line which is adapted to conduct at least part of the air which has been filtered by the filtering apparatus to a consumer device which is present on board an aircraft equipped with the cabin air extraction system.

In the cabin air extraction system, the waste air which is to be discharged from the aircraft cabin is not discharged, as in conventional cabin air extraction systems, directly to the environment around the aircraft. On the contrary, the air which has been filtered by means of the filtering apparatus is reused on board the aircraft equipped with the cabin air extraction system. The consumer device which is present on board the aircraft equipped with the cabin air extraction system and which is supplied with filtered air by the cabin air extraction system may be, for example, an apparatus which is to be cooled or an aircraft air-conditioning installation. Through the reuse of the waste air discharged from the aircraft cabin, the quantity of air which is discharged to the environment around the aircraft by the cabin air extraction system can be reduced. This permits a reduction in the aerodynamic losses caused by the discharge of air from the aircraft to the environment around the latter, and thereby a reduction in the aircraft's fuel consumption. Moreover, the reuse of cabin waste air permits a reduction in the air which is to be fed to the consumer device from outside the aircraft, thereby causing further aerodynamic losses, or from other sources in an energy-intensive manner. For example, the use of filtered cabin waste air in the aircraft air-conditioning installation permits a reduction in the installation's requirement for recirculation air, as a result of which it is possible to design the recirculation air system of the aircraft air-conditioning installation to be smaller and lighter in weight. An aircraft equipped with the cabin air extraction system can thus be operated in a particularly energy-efficient and fuel-saving manner.

In one embodiment of the cabin air extraction system, the conveying apparatus is arranged upstream of the filtering apparatus in the cabin waste air line. As an alternative to this, the conveying apparatus may be arranged downstream of the filtering apparatus in the filtered air line. In the context of this Application, the terms “upstream” and “downstream” refer to the direction of flow of the cabin waste air through the cabin waste air line and the direction of flow of the filtered air through the filtered air line, respectively.

The filtering apparatus may comprise only one filter, which may be arranged in a main cabin waste air line downstream or upstream of the conveying apparatus. As an alternative to this, however, it is also conceivably possible to equip the filtering apparatus with a number of filters which may then be arranged, either in the main cabin waste air line or in branch cabin waste air lines that branch off from the main cabin waste air line. The conveying apparatus may comprise only one conveying appliance which is constructed, for example, in the form of a blower and which may be arranged upstream of the filtering apparatus in the main cabin waste air line or downstream of the filtering apparatus in a main filtered air line. As an alternative to this, however, it is also conceivably possible to equip the conveying apparatus with a number of conveying appliances which may then be arranged in the main cabin waste air line or the main filtered air line or in branch filtered air lines that branch off from the main filtered air line.

In one preferred embodiment of the cabin air extraction system, the filtering apparatus comprises a rotary absorber which is rotatable about an axis of rotation, so that an absorption section of the rotary absorber can be positioned in the cabin waste air line and used for filtering the cabin waste air flowing through the cabin waste air line, while a desorption section of the rotary absorber can be positioned outside the cabin waste air line and be regenerated by the feeding-in of regeneration energy. In a filtering apparatus equipped with a rotary absorber, a freshly regenerated filtering section for filtering the cabin waste air discharged from the aircraft cabin via the cabin waste air line is therefore always available by means of the absorption section, while the desorption section of the rotary absorber is regenerated at the same time. The filtering apparatus can thus be operated continuously without breaks in operation and with low loss of pressure via the filtering apparatus, and is therefore distinguished by high effectiveness and efficiency. The filtering apparatus can also be operated with little outlay on maintenance since, because of the regeneration of the rotary absorber in the course of operation, it is not necessary to replace the filter medium provided in the filtering apparatus.

The desorption section of the rotary absorber may be arranged in an outlet line connected to the environment around the aircraft. Air flowing through the outlet line may then be used to carry with it substances that have been desorbed by the absorption section of the rotary absorber, and to discharge them to the environment around the aircraft.

The outlet line may, for example, branch off from the cabin waste air line upstream of the filtering apparatus. The outlet line then has unfiltered cabin waste air, which is discharged from the aircraft cabin via the cabin waste air line, flowing through it. As an alternative, or in addition, to this, the outlet line may branch off from the cabin waste air line downstream of the conveying apparatus. The conveying apparatus then conveys the cabin waste air discharged from the aircraft cabin in a parallel manner both through the cabin waste air line and through the outlet line. The outlet line may be connected to an outlet valve for controlling the discharge of air into the environment around the aircraft. By means of the outlet valve, the quantity of air discharged to the environment around the aircraft can be controlled as desired. The outlet valve in question may be one which is associated only with the outlet line of the cabin air extraction system. However, the outlet line of the cabin air extraction system is preferably connected to an outlet valve which is present on board the aircraft in any case and which serves, for example, to control the pressure in the aircraft cabin.

As an alternative to this, the outlet line may branch off from the filtered air line downstream of the filtering apparatus. The outlet line then has air which has been filtered by means of the filtering apparatus flowing through it. If desired, the branching-off of the outlet line from the filtered air line may also take place downstream of a conveying apparatus arranged in the filtered air line. The outlet line is then preferably connected to a nozzle for the discharge, which is driven by differential pressure, of air into the environment around the aircraft. The nozzle may, for example, be adapted to produce a negative pressure in the area of an air discharge aperture constructed in an outer skin of the aircraft, so that the filtered air is conveyed through the outlet line as a result of the pressure difference developing between the pressure in the outlet line and the lower pressure in the area of the air discharge aperture, and is finally discharged into the environment around the aircraft.

Moreover, the cabin waste air line may be connected via a bypass line, upstream of the filtering apparatus, to an air discharge aperture constructed in the outer skin of the aircraft. In particular, the bypass line may open into a nozzle which is adapted to produce a negative pressure in the area of the air discharge aperture constructed in the outer skin of the aircraft. A valve arranged in the bypass line may serve to control the flow of cabin waste air through the bypass line. An arrangement of this kind makes it possible to conduct the air discharged from the aircraft cabin directly away into the environment around the aircraft if necessary, for example in the event of failure of the filtering apparatus.

The cabin air extraction system may also comprise a heating apparatus which may be adapted to feed regeneration energy in the form of thermal energy to the desorption section of the rotary absorber. The heating apparatus may be constructed, for example, in the form of an electric heating apparatus or in the form of a heat source which is present in any case on board an aircraft equipped with the cabin air extraction system, and the heating apparatus guarantees rapid regeneration of the desorption section of the rotary absorber. In one preferred embodiment of the cabin air extraction system, the heating apparatus is adapted to warm up cabin waste air or filtered air flowing through the outlet line, before the cabin waste air or the filtered air flows through the desorption section of the rotary absorber. As a result of the warming-up of the cabin waste air flowing through the outlet line, or the filtered air flowing through the outlet line, uniform warming-through of the desorption section of the rotary absorber, and thereby optimum regeneration of the latter, are made possible.

In addition, or as an alternative, to a rotary absorber, the filtering apparatus may comprise a tube filter arranged in the cabin waste air line. By means of a filtering apparatus comprising a tube filter, the whole of the waste air discharged from the aircraft cabin can be filtered and fed to the consumer device which is present on board the aircraft equipped with the cabin air extraction system. This permits particularly efficient and fuel-saving operation of an aircraft equipped with the cabin air extraction system. The tube filter may, for example, be of tubular design and preferably extends coaxially in relation to the cabin waste air line. Moreover, the tube filter may preferably be capable of having the cabin waste air that flows through the cabin waste air line flowing through the filter in the radial direction. What is achieved as a result of this is a low speed of flow through the tube filter and consequently high filtering efficiency.

In a method for operating a cabin air extraction system, waste air to be discharged from an aircraft cabin is conveyed through a cabin waste air line by means of a conveying apparatus. At least part of the cabin waste air flowing through the cabin waste air line is filtered by means of a filtering apparatus. At least part of the air filtered by means of the filtering apparatus is conducted through a filtered air line to a consumer device which is present on board an aircraft equipped with the cabin air extraction system.

The waste air to be discharged from the aircraft cabin may be conveyed through the cabin waste air line by means of a conveying apparatus which is arranged upstream of the filtering apparatus in the cabin waste air line. As an alternative to this, the waste air to be discharged from the aircraft cabin may be conveyed through the cabin waste air line by means of a conveying apparatus which is arranged downstream of the filtering apparatus in the filtered air line.

The filtering apparatus may comprise a rotary absorber which is rotatable about an axis of rotation, so that an absorption section of the rotary absorber is positioned in the cabin waste air line and is used for filtering the cabin waste air flowing through the cabin waste air line, while a desorption section of the rotary absorber is positioned outside the cabin waste air line and is regenerated by the feeding-in of regeneration energy.

The desorption section of the rotary absorber may be arranged in an outlet line connected to the environment around the aircraft and may have cabin waste air from the cabin waste air line or filtered air from the filtered air line flowing through it. The cabin waste air or the filtered air may be conveyed through the outlet line by means of the conveying apparatus or in a manner driven by differential pressure.

As an alternative, or in addition, to a rotary absorber, the filtering apparatus may comprise a tube filter arranged in the cabin waste air line. The tube filter may extend coaxially in relation to the cabin waste air line and have the cabin waste air that flows through the cabin waste air line flowing through the filter in the radial direction.

An aircraft air-conditioning system comprises an aircraft air-conditioning installation and also a cabin air extraction system which has been described above. The aircraft air-conditioning installation may comprise at least one air-conditioning unit to which process air which is hot and at an elevated pressure and which is taken, either from engine compressors or auxiliary engine compressors of an aircraft equipped with the aircraft air-conditioning system, or is produced by a separate compressor, is fed. Moreover, the aircraft air-conditioning installation may comprise a mixer to which cooled fresh air which has been processed in the air-conditioning unit(s) and also recirculation air which has been sucked out of a passenger cabin of the aircraft is fed. Finally the aircraft air-conditioning installation may comprise a plurality of air-carrying lines. In particular, the aircraft air-conditioning installation may comprise at least one process air line for feeding-in process air to the air-conditioning unit(s), at least one fresh air line connecting the air-conditioning unit(s) to the mixer, at least one recirculation air line for discharging recirculation air from the aircraft passenger cabin into the mixer of the aircraft air-conditioning installation, and/or at least one air-conditioning air line for feeding air-conditioning air from the mixer into an area of the aircraft which is to be air-conditioned.

The filtered air line of the cabin air extraction system is preferably connected to a line belonging to the aircraft air-conditioning installation and carrying air-conditioning air. The line in question that carries air-conditioning air and belongs to the aircraft air-conditioning installation may be, for example, a collecting line (supply duct) through which air-conditioning air is fed to the aircraft passenger cabin by the mixer belonging to the aircraft air-conditioning installation, and which is located, for example, in a side wall area behind or above luggage compartments which are present in the passenger cabin. As an alternative to this, the air-conditioning air may also be used for cargo hold-cooling or appliance-cooling.

### BRIEF DESCRIPTION OF THE DRAWINGS

Preferred embodiments of the invention will now be explained in greater detail with the aid of the appended diagrammatic drawings, in which:

FIG. 1 shows an embodiment of a cabin air extraction system which comprises a filtering apparatus having a rotary absorber;

FIG. 2 shows another embodiment of a cabin air extraction system which comprises a filtering apparatus having a rotary absorber;

FIG. 3 shows an embodiment of a cabin air extraction system which comprises a filtering apparatus having a tube filter; and

FIG. 4 shows a detail representation of the filtering apparatus of the cabin air extraction system according to FIG. 3.

### DETAILED DESCRIPTION OF THE PREFERRED EMBODIMENTS

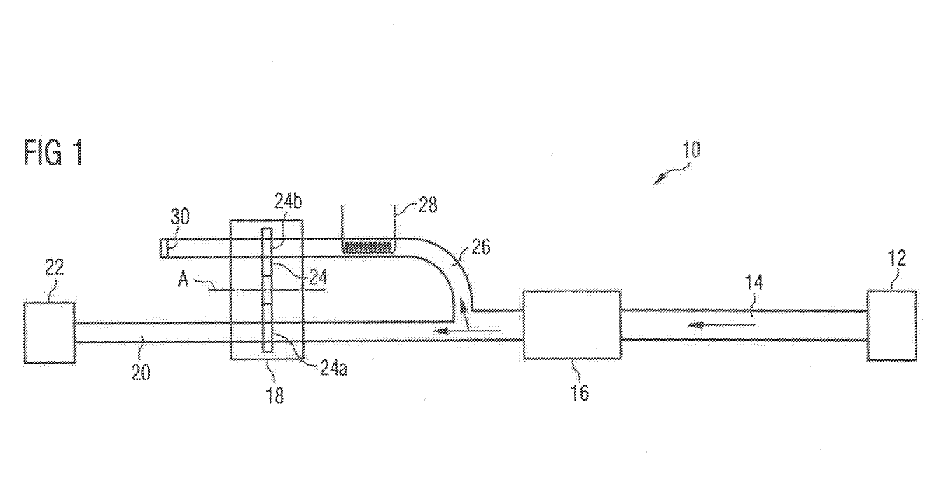

FIG. 1 shows a cabin air extraction system 10 which serves to discharge waste air and, in particular, unpleasant odors from an aircraft cabin 12. The cabin air extraction system 10 comprises a cabin waste air line 14, the first end of which is connected to the aircraft cabin 12, for example to a galley area of the aircraft cabin 12. A conveying apparatus 16, which in this case is constructed in the form of a blower, serves to convey, through the cabin waste air line 14, the cabin waste air which is to be discharged from the aircraft cabin 12. Arranged in the cabin waste air line 14 is a filtering apparatus 18 which is adapted to filter at least part of the cabin waste air flowing through the cabin waste air line 14.

In the arrangement shown in FIG. 1, the filtering apparatus 18 is arranged downstream of the conveying apparatus 16 in the cabin waste air line 14, that is to say, the conveying apparatus 16 is positioned upstream of the filtering apparatus 18 in the cabin waste air line 14. Extending downstream of the filtering apparatus 18 is a filtered air line 20 which is adapted to conduct at least part of the air filtered by the filtering apparatus 18 to a consumer device 22 which is present on board an aircraft equipped with the cabin air extraction system 10. The consumer device 22 in question may be an apparatus which is to be cooled, an aircraft air-conditioning installation or a component of the aircraft air-conditioning installation. For example, the filtered air line 20 may open into a line belonging to the aircraft air-conditioning installation and carrying air-conditioning air, as will be explained in greater detail later on.

In the cabin air extraction system 10 illustrated in FIG. 1, the filtering apparatus 18 comprises a rotary absorber 24 which is loaded with activated carbon. The rotary absorber 24, which is of substantially disc-shaped construction, is rotatable about an axis of rotation A and comprises an absorption section 24a and also a desorption section 24b. The absorption section 24a is positioned in the cabin waste air line 14 and can consequently be used for filtering the cabin waste air flowing through the cabin waste air line 14. The desorption section 24b, on the other hand, is arranged outside the cabin waste air line 14 and can be regenerated by the feeding-in of regeneration energy.

As soon as the activated carbon which is present in the absorption section 24a of the rotary absorber 24 is used up, and consequently the filtering action of the latter declines, the rotary absorber 24 can be rotated by 180° about the axis of rotation A. As a result of this, the former desorption section 24b passes into the position in the cabin waste air line 14 previously occupied by the former absorption section 24a, where it can be used for filtering the cabin waste air flowing through the cabin waste air line 14. The former absorption section 24a, on the other hand, passes into the position outside the cabin waste air line 14 previously occupied by the former desorption section 24b, and can be regenerated by the feeding-in of regeneration energy. The rotary absorber 24 can consequently be operated continuously with high filtering effectiveness.

The desorption section 24b of the rotary absorber 24 is arranged in an outlet line 26 which is connected to an environment around the aircraft. In the arrangement according to FIG. 1, the outlet line 26 branches off from the cabin waste air line 14 upstream of the filtering apparatus 18 and downstream of the conveying apparatus 16 and consequently has, flowing through it, waste air which is discharged from the aircraft cabin 12 and which is conveyed through the outlet line 26 by means of the conveying apparatus 16. A heating apparatus 28 serves to feed regeneration energy in the form of thermal energy to the desorption section 24b of the rotary absorber 24. In particular, the heating apparatus 28 is adapted to warm up the cabin waste air flowing through the outlet line 26 before the cabin waste air is conducted through the desorption section 24b of the rotary absorber 24. This makes possible uniform warming-through and efficient regeneration of the activated carbon present in the desorption section 24b of the rotary absorber 24. Moreover, substances which are desorbed during the regeneration operation by the activated carbon present in the desorption section 24b of the rotary absorber 24 are entrained by the flow of cabin waste air flowing through the outlet line 26 and conducted away into the environment around the aircraft.

The outlet line 26 is connected to an outlet valve 30. By means of the outlet valve 30, it is possible to control the flow of cabin waste air through the outlet line 26 and, in particular, the discharge of the cabin waste air flowing through the outlet line 26 to the environment around the aircraft, as desired. The outlet valve 30 may be associated exclusively with the cabin air extraction system 10. Preferably, however, the outlet line 26 is connected to an outlet valve 30 which is present in any case on board the aircraft and which serves, for example, to control the pressure in the aircraft cabin 12.

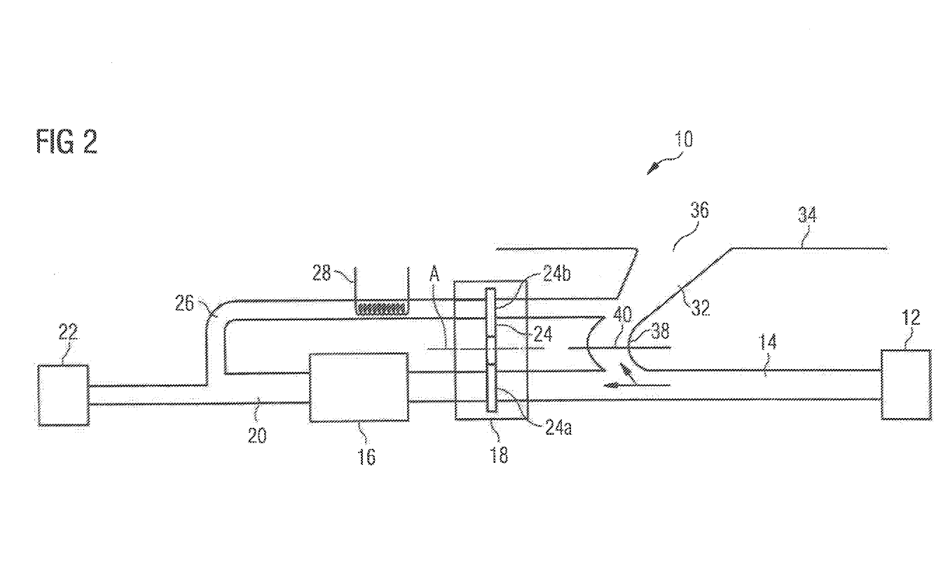

The cabin air extraction system 10 shown in FIG. 2 differs from the arrangement according to FIG. 1 through the fact that the conveying apparatus 16 is no longer arranged upstream of the filtering apparatus 18 in the cabin waste air line 14, but downstream of the filtering apparatus 18 in the filtered air line 20. Moreover, in the cabin air extraction system 10 illustrated in FIG. 2, the outlet line 26 branches off from the filtered air line 20 downstream of the filtering apparatus 18 and the conveying apparatus 16, and consequently has filtered air flowing through it. Accordingly, the heating apparatus 28 does not warm up cabin waste air which is branched off from the cabin waste air line 14, but filtered air which is taken from the filtered air line 20.

The filtered air flowing through the outlet line 26 is conveyed through the outlet line 26 in a manner driven by differential pressure. For this purpose, the outlet line 26 is connected to a nozzle 32 which is arranged in the area of an air discharge aperture 36 provided in an outer skin 34 of the aircraft. The nozzle 32 produces a negative pressure in the area of the air discharge aperture 36, so that a pressure difference develops between the pressure in the outlet line 26 and the pressure in the area of the air discharge aperture 36. This makes it possible to achieve a conveyance of filtered air through the outlet line 26 which is driven by differential pressure.

Finally, the cabin air extraction system 10 according to FIG. 2 comprises a bypass line 38 which branches off from the cabin waste air line 14 upstream of the filtering apparatus 18 and connects the cabin waste air line 14 to the nozzle 32. The flow of cabin waste air through the bypass line 38 is controlled by a valve 40 which is arranged in the bypass line 38. Via the bypass line 38, the cabin waste air flowing through the cabin waste air line 14 can be discharged to the environment around the aircraft if necessary, for example in the event of failure of the filtering apparatus 18. In other respects, the structure and mode of operation of the cabin air extraction system 10 according to FIG. 2 correspond to the structure and mode of operation of the arrangement according to FIG. 1.

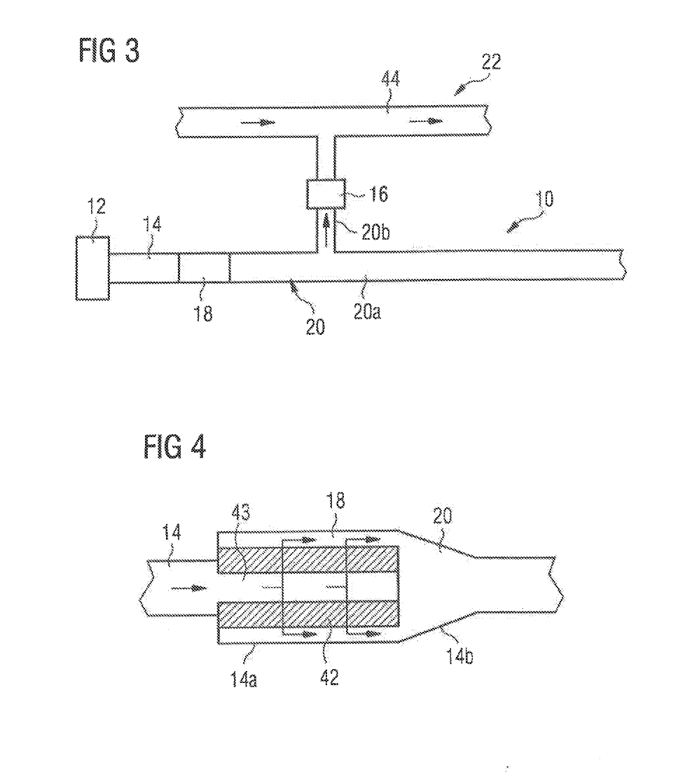

The cabin air extraction system 10 shown in FIG. 3 differs from the arrangement according to FIG. 2 through the fact that the filtering apparatus 18 no longer comprises a rotary absorber 24, but a tube filter 42 which is illustrated in a detailed manner in FIG. 4. The tube filter 42 is loaded with activated carbon and arranged in the cabin waste air line 14. No provision is made for regeneration of the tube filter 42 in the course of operation. In the system 10 represented in FIG. 3, it is therefore possible to dispense with the heating apparatus 28 which is present in the cabin air extraction system 10 according to FIG. 2, as well as with the outlet line 26. Moreover, the cabin air extraction system 10 shown in FIG. 3 comprises no bypass line 38 and can therefore be of smaller and lighter design, overall, than the system 10 according to FIG. 2. However, the cabin air extraction system 10 according to FIG. 3 requires a higher outlay on maintenance than the arrangement according to FIG. 2, since the tube filter 42 has to be replaced when the filter medium contained in the tube filter 42 is used up or clogged.

Moreover, in the cabin air extraction system 10 according to FIG. 3, the conveying apparatus 16 constructed in the form of a blower is no longer arranged in a main filtered air line 20a, but in a branch filtered air line 20b which branches off from the main filtered air line 20a. The branch filtered air line 20b connects the main filtered air line 20a to a line 44 belonging to an aircraft air-conditioning installation and carrying air-conditioning air. The line 44 carrying air-conditioning air may be, for example, a collecting line (supply duct) through which air-conditioning air is fed to an aircraft passenger cabin. As an alternative to this, the air-conditioning air from the line 44 may also be used for cargo hold-cooling or appliance-cooling. In other respects, the structure and mode of operation of the cabin air extraction system 10 according to FIG. 3 correspond to the structure and mode of operation of the arrangement according to FIG. 2.

In the embodiment illustrated in FIG. 4, the tube filter 42 is of tubular construction, extends coaxially in relation to the cabin waste air line 14 and can have the cabin waste air that flows through the cabin waste air line 14 flowing through the filter in the radial direction. In the embodiment according to FIG. 4, the tube filter 42 is inserted in a section 14a of the cabin waste air line 14 that has an expanded cross-section in comparison to a section of the cabin waste air line 14 that extends upstream of the tube filter 42. Downstream of the tube filter 42, a section 14b of the cabin waste air line 14 extends with a cross-section which narrows continuously until the cabin waste air line 14 reaches its original cross-section again.

The cabin waste air which flows through the cabin waste air line 14 in the axial direction upstream of the tube filter 42 is conducted into an inner cavity 43 of the tube filter 42, where it is deflected radially. The cabin waste air then flows through the tube filter 42 in the radial direction before being deflected axially again, after flowing through the tube filter 42, on an inner wall of the section 14a of the cabin waste air line 14 having an expanded cross-section. By guiding the flow in this way, a speed of flow through the tube filter 42 is achieved which is sufficiently low to guarantee a desired filtering effectiveness of the tube filter 42.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A cabin air extraction system having:
a cabin waste air line in which cabin waste air moves in a downstream direction;
a conveying apparatus configured to convey, through said cabin waste air line, waste air to be discharged from an aircraft cabin,
a filtering apparatus configured to filter at least part of the cabin waste air flowing through the cabin waste air line, and
a filtered air line configured to conduct at least part of the air which has been filtered by the filtering apparatus in a downstream direction to a consumer device present on board an aircraft equipped with the cabin air extraction system.

2. The cabin air extraction system according to claim 1, wherein the conveying apparatus is arranged upstream of the filtering apparatus in the cabin waste air line.

3. The cabin air extraction system according to claim 1, wherein the conveying apparatus is arranged downstream of the filtering apparatus in the filtered air line.

4. The cabin air extraction system according to claim 1, wherein the filtering apparatus comprises a rotary absorber rotatable about an axis of rotation, so that an absorption section of said rotary absorber is positioned in the cabin waste air line and is used for filtering the cabin waste air flowing through said cabin waste air line, while a desorption section of said rotary absorber is positioned outside the cabin waste air line and is regenerated by the feeding-in of regeneration energy.

5. The cabin air extraction system according to claim 4, wherein the desorption section of the rotary absorber is arranged in an outlet line connected to an environment exterior of the aircraft.

6. The cabin air extraction system according to claim 5, wherein the outlet line branches off from the cabin waste air line upstream of the filtering apparatus and downstream of the conveying apparatus and is connected to an outlet valve for controlling the discharge of air into the environment exterior of the aircraft.

7. The cabin air extraction system according to claim 5, wherein the outlet line branches off from the filtered air line downstream of the filtering apparatus and the conveying apparatus and is connected to a nozzle for the discharge, which nozzle is driven by differential pressure, of air into the environment exterior of the aircraft.

8. The cabin air extraction system according to claim 4, further comprising a heating apparatus configured to feed regeneration energy in the form of thermal energy to the desorption section of the rotary absorber, wherein said heating apparatus is configured to warm up cabin waste air or filtered air flowing through the outlet line, before the cabin waste air or the filtered air flows through the desorption section of the rotary absorber.

9. The cabin air extraction system according to claim 1, wherein the filtering apparatus comprises a tube filter arranged in the cabin waste air line and extending coaxially in relation to said cabin waste air line and configured to have the cabin waste air that flows through the cabin waste air line, flowing through said filter in a radial direction.

10. A method for operating a cabin air extraction system, comprising the steps:
conveying waste air, to be discharged from an aircraft cabin, through a cabin waste air line by a conveying apparatus,
filtering at least part of the cabin waste air flowing through the cabin waste air line by a filtering apparatus, and
conducting at least part of the air filtered by said filtering apparatus through a filtered air line to a consumer device present on board an aircraft equipped with the cabin air extraction system.

11. The method according to claim 10, wherein the filtering apparatus comprises a rotary absorber rotatable about an axis of rotation, so that an absorption section of said rotary absorber is positioned in the cabin waste air line and is used for filtering the cabin waste air flowing through said cabin waste air line, while a desorption section of said rotary absorber is positioned outside the cabin waste air line and is regenerated by the feeding-in of regeneration energy.

12. The method according to claim 11, wherein the desorption section of the rotary absorber is arranged in an outlet line connected to an environment exterior of the aircraft and has cabin waste air from the cabin waste air line or filtered air from the filtered air line flowing through it, wherein the cabin waste air or the filtered air is conveyed through the outlet line by the conveying apparatus.

13. The method according to claim 11, wherein the desorption section of the rotary absorber is arranged in an outlet line connected to an environment exterior of the aircraft and has cabin waste air from the cabin waste air line or filtered air from the filtered air line flowing through it, wherein the cabin waste air or the filtered air is conveyed through the outlet line by differential pressure.

14. The method according to claim 11, wherein a heating apparatus feeds regeneration energy in the form of thermal energy to the desorption section of the rotary absorber, wherein said heating apparatus warms up cabin waste air flowing through the outlet line, before the cabin waste air flows through the desorption section of the rotary absorber.

15. The method according to claim 11, wherein a heating apparatus feeds regeneration energy in the form of thermal energy to the desorption section of the rotary absorber, wherein said heating apparatus warms up filtered air flowing through the outlet line, before the filtered air flows through the desorption section of the rotary absorber.

16. The method according to claim 10, wherein the filtering apparatus comprises a tube filter arranged in the cabin waste air line and extending coaxially in relation to said cabin waste air line and being configured to have the cabin waste air that flows through the cabin waste air line flow through said filter in a radial direction.

17. An aircraft air-conditioning system comprising:
an aircraft air-conditioning installation, and
a cabin air extraction system comprising:
a cabin waste air line in which cabin waste air moves in a downstream direction;
a conveying apparatus configured to convey, through said cabin waste air line, waste air to be discharged from an aircraft cabin,
a filtering apparatus configured to filter at least part of the cabin waste air flowing through the cabin waste air line, and
a filtered air line configured to conduct at least part of the air which has been filtered by the filtering apparatus in a downstream direction to a consumer device present on board an aircraft equipped with the cabin air extraction system,
wherein the filtered air line of said cabin air extraction system is connected to a line belonging to the aircraft air-conditioning installation and carrying air-conditioning air.
